(19) United States
(12) Patent Application Publication
(10) Pub. No.: US 2015/0287516 A1
(43) Pub. Date: Oct. 8, 2015

(54) MULTILAYER ELECTRONIC COMPONENT AND MANUFACTURING METHOD THEREOF

(71) Applicant: SAMSUNG ELECTRO-MECHANICS CO., LTD., Suwon-si (KR)

(72) Inventor: Yong Sun PARK, Suwon-Si (KR)

(73) Assignee: SAMSUNG ELECTRO-MECHANICS CO., LTD., Suwon-Si (KR)

(21) Appl. No.: 14/454,630

(22) Filed: Aug. 7, 2014

(30) Foreign Application Priority Data
Apr. 2, 2014 (KR) 10-2014-0039440

(51) Int. Cl. H01F 27/28; H01F 27/29; H01F 41/04

(52) U.S. Cl. CPC H01F 27/2804; H01F 41/04; H01F 27/292; H01F 2027/2809

(57) ABSTRACT

A multilayer electronic component, when an internal coil is formed to be perpendicular to insulating layers stacked in a ceramic body and external electrodes are formed on one surface (a lower surface) of a chip device facing a board at the time of being mounted on the board, a surface of a ceramic body to which the internal coil is exposed and on which the external electrodes are to be formed may be easily distinguished.

### CROSS-REFERENCE TO RELATED APPLICATION

This application claims the benefit of Korean Patent Application No. 10-2014-0039440 filed on Apr. 2, 2014, with the Korean Intellectual Property Office, the disclosure of which is incorporated herein by reference.

### BACKGROUND

The present disclosure relates to a multilayer electronic component and a manufacturing method thereof.

An inductor, an electronic component, is a representative passive element forming an electronic circuit, together with a resistor and a capacitor, to remove noise. Such an inductor is combined with the capacitor through electromagnetic characteristics to configure a resonance circuit amplifying a signal within a specific frequency band, a filter circuit, or the like.

In the case of a multilayer inductor, inductance may be generated by forming coil patterns, using a conductive paste, or the like, on insulating sheets mainly formed of a magnetic material or a dielectric material and stacking the insulating sheets having the coil patterns to form a coil in a sintered body.

In order to generate a higher degree of inductance, a multilayer inductor, in which an internal coil is formed in a direction perpendicular with respect to a mounting surface of the inductor, is well known in the art to which the present disclosure pertains. Such a multilayer inductor may obtain a high degree of inductance, as compared to a multilayer inductor in which an internal coil is formed in a direction parallel with respect to a mounting surface of the inductor, as well as an increase in self resonant frequency.

Meanwhile, external electrodes for connecting the internal coil to an external circuit are formed on a multilayer inductor. When the external electrodes are formed on both end surfaces of a sintered multilayer body in a length direction and on portions of surfaces adjacent to the end surfaces, by performing a dipping method using a conductive paste, or the like, the thickness of the external electrodes may be increased and there may be limitations on miniaturizing a chip device.

Particularly, in the case in which the external electrodes are formed to be parallel to the internal coil on both end surfaces of the body in the length direction in the multilayer inductor in which the internal coil is perpendicular to the mounting surface, an eddy current may be generated in the external electrodes, causing an increase in loss, and stray capacitance may be generated between the internal coil and the external electrodes. This stray capacitance may cause a decrease in the self resonant frequency of the inductor.

Accordingly, in such a multilayer inductor, attempts to form external electrodes on one surface (a lower surface) of a chip device facing a board, at the time of mounting the chip device on the board, have been made to miniaturize the chip device and suppress loss due to the generation of the eddy current.

However, in the case of forming external electrodes on both end surfaces of a multilayer body in a length direction according to the related art, since shapes of both end surfaces in the length direction differ, as compared to shapes of the remaining surfaces of the multilayer body, the surfaces of the multilayer body on which the external electrodes are to be formed may be easily distinguished, but since the shapes of the remaining surfaces are the same as one another, it may be difficult to distinguish a surface of the multilayer body to which an internal coil is exposed, from among the remaining surfaces.

### RELATED ART DOCUMENT

(Patent Document 1) Japanese Patent Laid-Open Publication No. 2011-014940

### SUMMARY

An exemplary embodiment in the present disclosure may provide a multilayer electronic component having an internal coil perpendicular to insulating layers stacked in a ceramic body, and external electrodes formed on one surface (a lower surface) of the electronic component facing a board at the time of being mounted on the board, in which the surface of the ceramic body to which the internal coil is exposed may be easily distinguished, and a method of manufacturing the same.

According to an exemplary embodiment in the present disclosure, a multilayer electronic component may include: a ceramic body in which a plurality of insulating layers are stacked; an internal coil part provided in the ceramic body through electrical connections between respective coil patterns provided on the plurality of insulating layers, and having first and second lead out portions which are exposed to the same surface of the ceramic body perpendicular to the stacked insulating layers; a marking layer provided on an entire region of at least one surface of the ceramic body parallel to the stacked insulating layers; and first and second external electrodes provided on the same surface of the ceramic body perpendicular to the stacked insulating layers, and connected to the first and second lead out portions of the internal coil part, respectively.

The marking layer may be disposed on both surfaces of the ceramic body parallel to the stacked insulating layers.

The marking layer may have a different color from that of the ceramic body.

The marking layer may contain a dielectric ceramic material.

The surface of the ceramic body to which the first and second lead out portions of the internal coil part are exposed may be distinguished by the marking layer.

The internal coil part may be perpendicular to a mounting surface of the ceramic body.

The first and second external electrodes may be extended to both side surfaces of the ceramic body in a width direction.

The extended portions of the first and second external electrodes, extended to the side surfaces of the ceramic body in the width direction, may contact the marking layer.

According to an exemplary embodiment in the present disclosure, a method of manufacturing a multilayer electronic component may include: preparing a plurality of insulating sheets; forming internal coil patterns on the insulating sheets; forming a multilayer body by stacking the insulating sheets on which the internal coil patterns are formed; stacking a marking sheet on at least one surface of the multilayer body parallel to the stacked insulating sheets; cutting the multilayer body to form a ceramic body including an internal coil part having first and second lead out portions which are exposed to the same surface of the ceramic body perpendicular to the stacked insulating sheets, and including a marking layer formed on an entire region of at least one surface of the ceramic body parallel to the stacked insulating sheets; and forming first and second external electrodes on the same surface of the ceramic body perpendicular to the stacked insulating sheets to be connected to the first and second lead out portions of the internal coil part, respectively.

The marking sheet may be stacked on both surfaces of the multilayer body parallel to the stacked insulating sheets.

The marking layer may have a different color from that of the ceramic body.

The marking layer may contain a dielectric ceramic material.

A plurality of marking sheets may be stacked on the at least one surface of the multilayer body parallel to the stacked insulating sheets.

In the forming of the first and second external electrodes, the surface of the ceramic body to which the first and second lead out portions of the internal coil part are exposed and on which the first and second external electrodes are to be formed may be distinguished by the marking layer.

The first and second external electrodes may be extended to both side surfaces of the ceramic body in a width direction.

The extended portions of the first and second external electrodes extended to the side surfaces of the ceramic body in the width direction may be formed to contact the marking layer.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a schematic perspective view illustrating a multilayer electronic component having an internal coil part according to an exemplary embodiment of the present disclosure;

FIG. 2 is an exploded perspective view of the multilayer electronic component according to the exemplary embodiment of the present disclosure;

FIG. 3 is a schematic perspective view of a multilayer electronic component according to an exemplary embodiment of the present disclosure, before forming external electrodes;

FIG. 4 is a schematic perspective view illustrating a multilayer electronic component having an internal coil part according to another exemplary embodiment of the present disclosure;

FIG. 5 is a flowchart illustrating a method of manufacturing a multilayer electronic component according to an exemplary embodiment of the present disclosure; and

FIGS. 6 through 8 are views illustrating a process of manufacturing a multilayer electronic component according to an exemplary embodiment of the present disclosure.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

### Multilayer Electronic Component

Hereinafter, a multilayer electronic component according to an exemplary embodiment of the present disclosure will be described with reference to the accompanying drawings. Particularly, a multilayer inductor will be described as an example of the multilayer electronic component, but the present disclosure is not limited thereto.

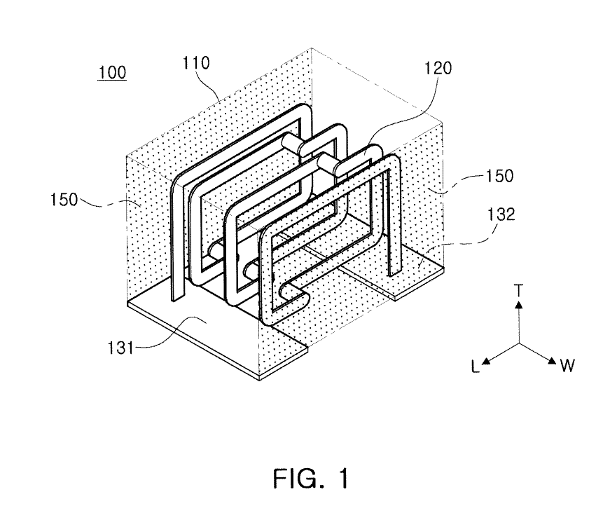

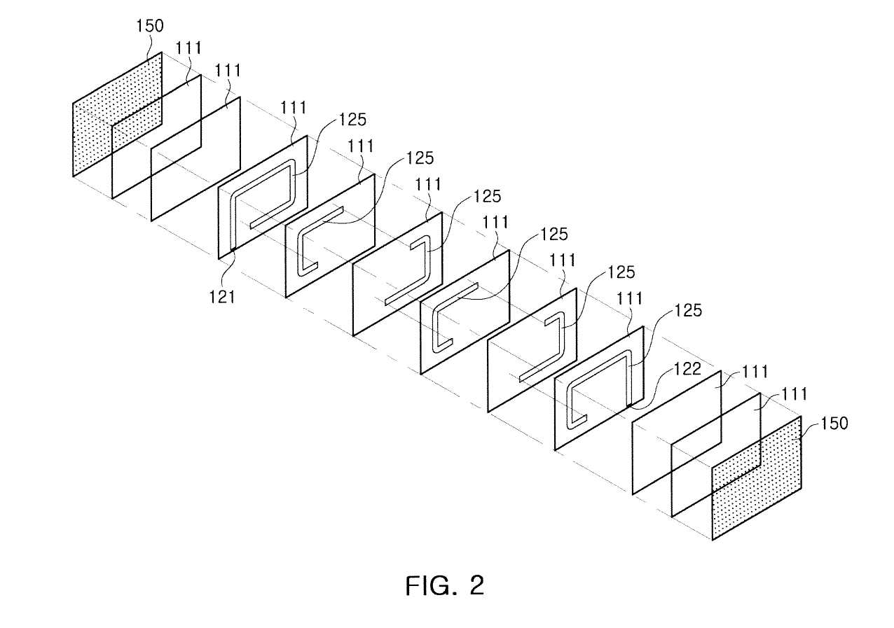

FIG. 1 is a schematic perspective view illustrating a multilayer electronic component having an internal coil part according to an exemplary embodiment of the present disclosure, and FIG. 2 is an exploded perspective view of the multilayer electronic component according to the exemplary embodiment of the present disclosure.

Referring to FIGS. 1 and 2, a multilayer electronic component 100 according to this exemplary embodiment of the present disclosure may include a ceramic body 110, an internal coil part 120, a marking layer 150, and first and second external electrodes 131 and 132.

The ceramic body 110 may be formed by stacking a plurality of insulating layers 111. The insulating layers 111 forming the ceramic body 110 may be in a sintered state, and adjacent insulating layers may be integrated with each other so that boundaries therebetween are not readily apparent without a scanning electron microscope (SEM).

The ceramic body 110 may have a hexahedral shape, and directions of a hexahedron will be defined in order to clearly describe the exemplary embodiment of the present disclosure. L, W, and T illustrated in FIG. 1 refer to a length direction, a width direction, and a thickness direction, respectively.

The ceramic body 110 may contain an Al₂O₃ based dielectric material or ferrite known in the art such as Mn—Zn based ferrite, Ni—Zn based ferrite, Ni—Zn—Cu based ferrite, Mn—Mg based ferrite, Ba based ferrite, Li based ferrite, or the like.

Internal coil patterns 125 may be formed by printing a conductive paste containing a conductive metal on the plurality of insulating layers 111 forming the ceramic body 110 at a predetermined thickness, and may be electrically connected to each other to thereby form the internal coil part 120.

A via may be formed in a predetermined position of each insulating layer 111 on which the internal coil pattern 125 is printed. The internal coil patterns 125 formed on the insulating layers 111 may be electrically connected to each other through the vias to thereby form a single coil.

The conductive metal forming the internal coil pattern 125 is not particularly limited as long as it has excellent electrical conductivity. For example, as the conductive metal, silver (Ag), palladium (Pd), aluminum (Al), nickel (Ni), titanium (Ti), gold (Au), copper (Cu), platinum (Pt), or the like, may be used alone or in combination.

In this case, as the plurality of insulating layers 111 having the internal coil patterns 125 are stacked in the width direction (W) or length direction (L), the internal coil part 120 may be formed in a direction perpendicular to a mounting surface of the ceramic body 110.

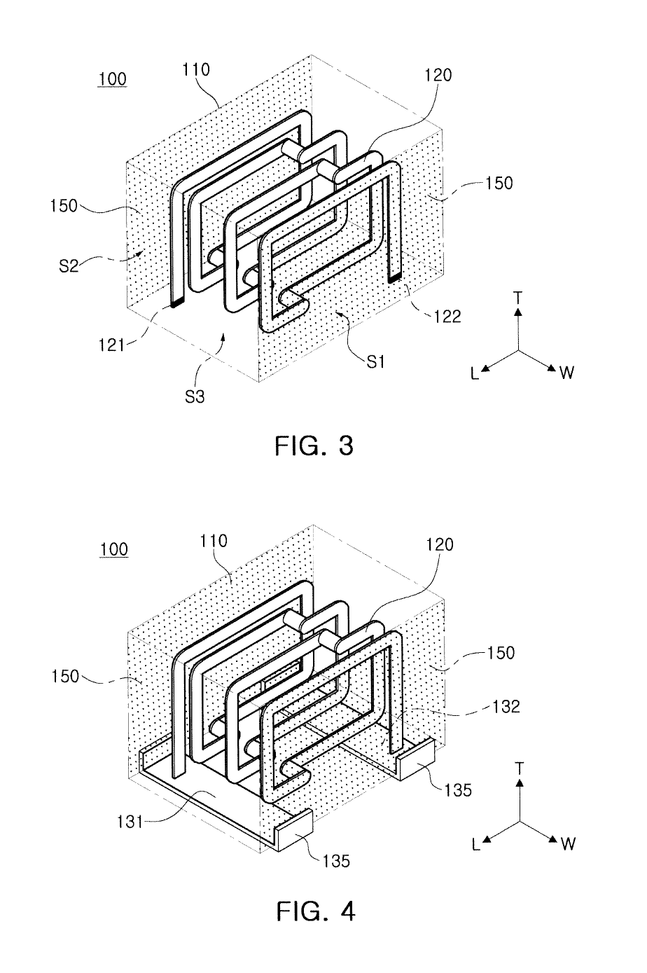

FIG. 3 is a schematic perspective view illustrating a multilayer electronic component according to an exemplary embodiment of the present disclosure, before forming external electrodes.

Referring to FIG. 3, first and second lead out portions 121 and 122 of the internal coil part 120 may be exposed to a surface of the ceramic body perpendicular to the stacked insulating layers 111. For example, the first and second lead out portions 121 and 122 may be exposed to a lower surface S₃, which is perpendicular to the stacked insulating layers 111, of the ceramic body 110 in the thickness (T) direction.

In this case, the first and second external electrodes 131 and 132 may be formed on the surface S₃ perpendicular to the stacked insulating layers 111, so as to be connected to the first and second lead out portions 121 and 122 of the internal coil part 120, respectively.

Here, in order to distinguish the surface of the ceramic body to which the first and second lead out portions 121 and 122 are exposed and on which the first and second external electrodes 131 and 132 are to be formed, the marking layer 150 may be formed on a surface of the ceramic body 110.

The marking layer 150 may be formed on a surface S₁ or S₂ of the ceramic body parallel to the stacked insulating layers 111, or may be formed on both surfaces S₁ and S₂ of the ceramic body parallel to the stacked insulating layers 111.

Since the marking layer 150 having a different color from that of the ceramic body 110 is formed on the entire region of the surface of the ceramic body 110 parallel to the stacked insulating layers 111, the surface of the ceramic body 110 to which the first and second lead out portions 121 and 122 are exposed and on which the first and second external electrodes 131 and 132 are to be formed may be easily distinguished.

The marking layer 150 may contain a dielectric ceramic material. The marking layer 150 may be formed of a dielectric sheet as the outmost layer of the ceramic body. In this case, a thickness of the marking layer 150 may be adjusted by stacking a plurality of dielectric sheets. For example, the thickness of the marking layer 150 may be 20 μm or greater.

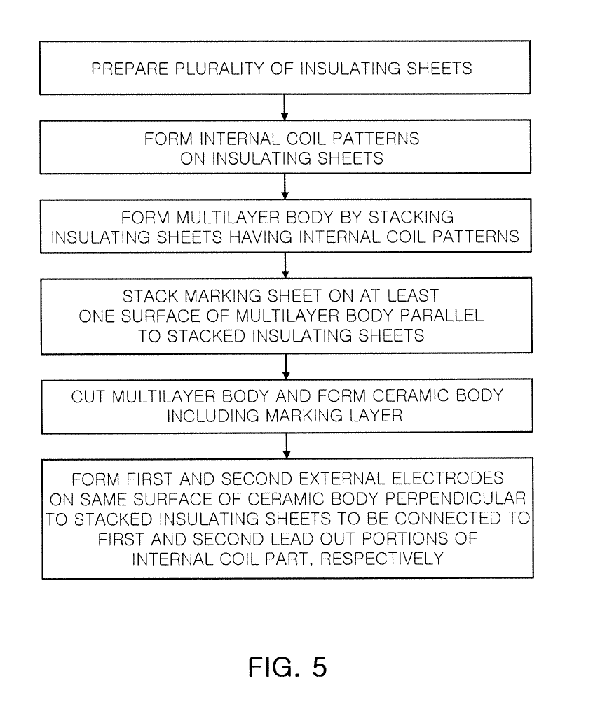

FIG. 4 is a schematic perspective view illustrating a multilayer electronic component having an internal coil part according to another exemplary embodiment of the present disclosure.

Referring to FIG. 4, first and second external electrodes 131 and 132 may be extended to both side surfaces of a ceramic body 110 in a width direction to thereby include extended portions 135.

In this case, the extended portions 135 of the first and second external electrodes 131 and 132 extended to both side surfaces of the ceramic body 110 in the width direction may be formed to contact marking layers 150.

Since a porosity in a sheet forming the marking layer 150 is higher than that in a sheet forming the ceramic body 110, a surface roughness of the marking layer 150 is larger than that of a surface of the ceramic body 110. By forming the extended portions 135 of the first and second external electrodes 131 and 132 to be in contact with the marking layer 150 having the relatively large surface roughness, adhesion strength of the external electrodes may be improved.

The first and second external electrodes 131 and 132 may be formed of a metal having excellent electrical conductivity. For example, the first and second external electrodes 131 and 132 may be formed of nickel (Ni), copper (Cu), tin (Sn), silver (Ag), or the like, or may be formed of an alloy thereof, or the like.

### Method of Manufacturing Multilayer Electronic Component

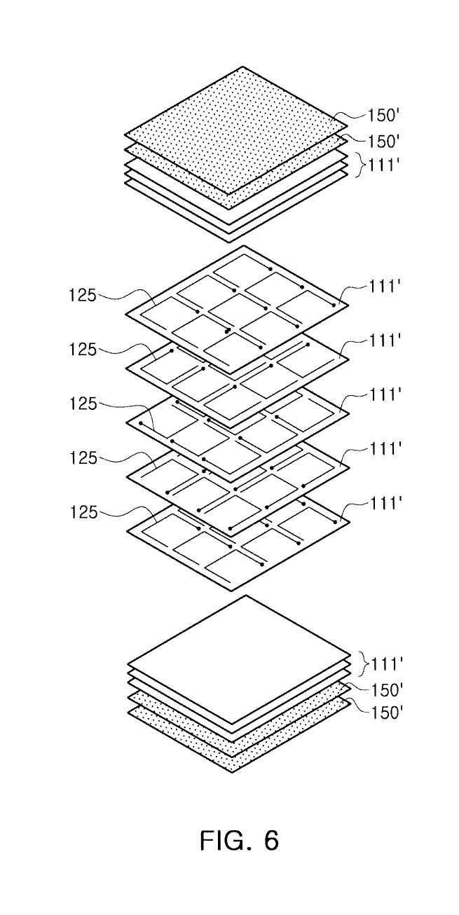

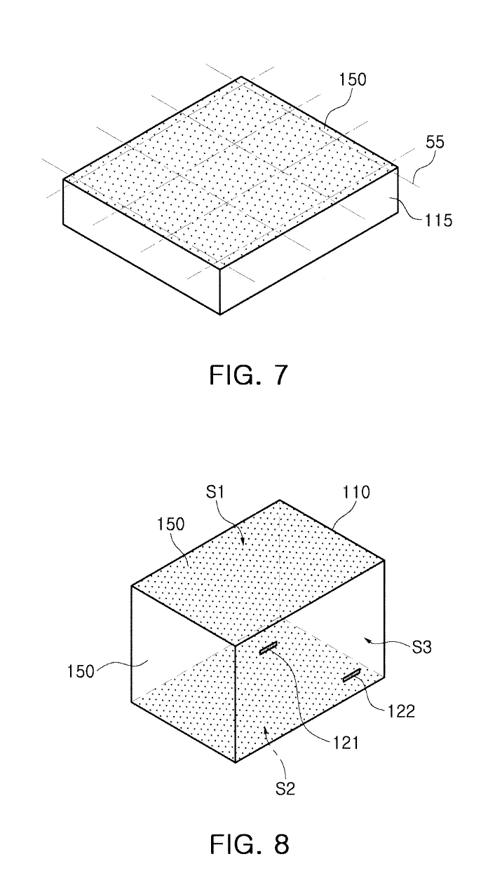

FIG. 5 is a flowchart illustrating a method of manufacturing a multilayer electronic component according to an exemplary embodiment of the present disclosure, and FIGS. 6 through 8 are views illustrating a process of manufacturing a multilayer electronic component according to an exemplary embodiment of the present disclosure.

Referring to FIGS. 5 and 6, a plurality of insulating sheets 111′ may be prepared.

An Al₂O₃ based dielectric powder, or a powder containing ferrite known in the art, such as Mn—Zn based ferrite, Ni—Zn based ferrite, Ni—Zn—Cu based ferrite, Mn—Mg based ferrite, Ba based ferrite, Li based ferrite, or the like, may be used for the insulating sheets 111′.

The plurality of insulating sheets 111′ may be prepared by applying a slurry formed by mixing the dielectric or magnetic material and an organic material to carrier films and drying the same.

Internal coil patterns 125 may be formed on the insulating sheets 111′

The internal coil patterns 125 may be formed by applying a conductive paste containing a conductive metal to the insulating sheets 111′ using a printing method or the like. The method of printing the conductive paste may include a screen printing method, a gravure printing method, or the like, but is not limited thereto.

A via may be formed in a predetermined position of each insulating sheet 111′ on which the internal coil pattern 125 is printed. The internal coil patterns 125 formed on the insulating sheets 111′ may be electrically connected to each other through the vias to thereby form an internal coil part 120.

The conductive metal is not particularly limited as long as it has excellent electrical conductivity. For example, as the conductive metal, silver (Ag), palladium (Pd), aluminum (Al), nickel (Ni), titanium (Ti), gold (Au), copper (Cu) platinum (Pt), or the like, may be used alone or in combination.

The insulating sheets 111′ having the internal coil patterns 125 may be stacked, and then the insulating sheets 111′ having no internal coil patterns may be stacked on the top and bottom of the stacked insulating sheets 111′ having the internal coil patterns 125, thereby forming a multilayer body 115.

At this time, a marking sheet 150′ may be further stacked on a surface of the multilayer body 115 parallel to the stacked insulating sheets 111′.

The marking sheet 150′ may be stacked on one surface or both surfaces of the multilayer body 115 parallel to the stacked insulating sheets 111′.

The marking sheet 150′ may contain a dielectric material, and a plurality of marking sheets 150 may be stacked to adjust a thickness of a marking layer 150 to be formed in a ceramic body 110.

Referring to FIG. 7, the multilayer body 115 having the marking sheet 150′ as the outermost layer may be cut along a cutting line 55 and be then sintered, thereby forming the ceramic body 110.

In this case, the ceramic body 110 may include the internal coil part 120 having first and second lead out portions 121 and 122 which are exposed to the same surface of the ceramic body perpendicular to the stacked insulating sheets ill′.

Referring to FIG. 8, the marking layer 150 may be formed on the entire region of a surface S₁ or S₂ of the ceramic body 110 parallel to the stacked insulating sheets in the ceramic body 110 formed by cutting and sintering the multilayer body 115.

Thereafter, first and second external electrodes 131 and 132 may be formed on the same surface S₃ of the ceramic body 110 perpendicular to the stacked insulating sheets so as to be connected to the first and second lead out portions 121 and 122 of the internal coil part 120, respectively,

In this case, the surface S₃ of the ceramic body 110 to which the first and second lead out portions 121 and 122 of the internal coil part 120 are exposed may be easily distinguished by the marking layer 150, such that the first and second external electrodes 131 and 132 are to be formed on the surface S₃ of the ceramic body 110. The ceramic body 110 may be disposed in an appropriate direction for the application of a conductive paste for the first and second external electrodes 131 and 132.

The first and second external electrodes 131 and 132 may be formed to include extended portions 135 extended to both side surfaces of the ceramic body 110 in a width direction.

In this case, the extended portions 135 of the first and second external electrodes 131 and 132 extended to both side surfaces of the ceramic body 110 in the width direction may be formed to be in contact with the marking layers 150.

Since a porosity in the marking sheet 150′ forming the marking layer 150 is higher than that in the insulating sheet 111′ forming the ceramic body 110, a surface roughness of the marking layer 150 is larger than that of the surface of the ceramic body 110. By forming the extended portions 135 of the first and second external electrodes 131 and 132 to be in contact with the marking layers 150 having the relatively large surface roughness, adhesion strength of the external electrodes may be improved.

The first and second external electrodes 131 and 132 may be formed using a conductive paste containing a metal having excellent electrical conductivity. For example, the conductive paste may include nickel (Ni), copper (Cu), tin (Sn), silver (Ag), or the like, or may include an alloy thereof, or the like.

Detailed features overlapped with those of the multilayer electronic component according to the previous exemplary embodiment of the present disclosure will be omitted.

As set forth above, according to exemplary embodiments of the present disclosure, in a case in which the internal coil is formed to be perpendicular to the insulating sheets stacked in the ceramic body and the external electrodes are formed on one surface (the lower surface) of the chip device facing the board at the time of being mounted on the board, the surface of the ceramic body to which the internal coil is exposed and on which the external electrodes are to be formed may be easily distinguished by the marking layer.

In addition, the extended portions of the external electrodes may be formed to contact the marking layer having the relatively large surface roughness, such that adhesion strength of the external electrodes is improved.

While exemplary embodiments have been illustrated and described above, it will be apparent to those skilled in the art that modifications and variations could be made without departing from the spirit and scope of the present disclosure as defined by the appended claims.

What is claimed is:

1. A multilayer electronic component, comprising:
a ceramic body including a plurality of stacked insulating layers;
an internal coil part provided in the ceramic body and including electrical connections between respective coil patterns provided on the plurality of insulating layers, and having first and second lead out portions which are exposed to a same surface of the ceramic body perpendicular to the stacked insulating layers;
a marking layer provided on an entire region of at least one surface of the ceramic body parallel to the stacked insulating layers; and
first and second external electrodes provided on the same surface of the ceramic body perpendicular to the stacked insulating layers, and connected to the first and second lead out portions of the internal coil part, respectively.

2. The multilayer electronic component of claim 1, wherein the marking layer is disposed on both surfaces of the ceramic body parallel to the stacked insulating layers.

3. The multilayer electronic component of claim 1, wherein the marking layer has a different color from that of the ceramic body.

4. The multilayer electronic component of claim 1, wherein the marking layer contains a dielectric ceramic material.

5. The multilayer electronic component of claim 1, wherein the surface of the ceramic body to which the first and second lead out portions of the internal coil part are exposed is distinguished by the marking layer.

6. The multilayer electronic component of claim 1, wherein the internal coil part is perpendicular to a mounting surface of the ceramic body.

7. The multilayer electronic component of claim 1, wherein the first and second external electrodes are extended to both side surfaces of the ceramic body in a width direction.

8. The multilayer electronic component of claim 7, wherein the extended portions of the first and second external electrodes, extended to the side surfaces of the ceramic body in the width direction, contact the marking layer.

9. A method of manufacturing a multilayer electronic component, the method comprising:
preparing a plurality of insulating sheets;
forming internal coil patterns on the insulating sheets;
forming a multilayer body by stacking the insulating sheets on which the internal coil patterns are formed;
stacking a marking sheet on at least one surface of the multilayer body parallel to the stacked insulating sheets;
cutting the multilayer body to form a ceramic body including an internal coil part having first and second lead out portions which are exposed to the same surface of the ceramic body perpendicular to the stacked insulating sheets, and including a marking layer formed on an entire region of at least one surface of the ceramic body parallel to the stacked insulating sheets; and
forming first and second external electrodes on the same surface of the ceramic body perpendicular to the stacked insulating sheets to be connected to the first and second lead out portions of the internal coil part, respectively.

10. The method of claim 9, wherein the marking sheet is stacked on both surfaces of the multilayer body parallel to the stacked insulating sheets.

11. The method of claim 9, wherein the marking layer has a different color from that of the ceramic body.

12. The method of claim 9, wherein the marking layer contains a dielectric ceramic material.

13. The method of claim 9, wherein a plurality of marking sheets are stacked on the at least one surface of the multilayer body parallel to the stacked insulating sheets.

14. The method of claim 9, wherein the surface of the ceramic body to which the first and second lead out portions of the internal coil part are exposed and on which the first and second external electrodes are to be formed is distinguished by the marking layer.

15. The method of claim 9, wherein the first and second external electrodes are extended to both side surfaces of the ceramic body in a width direction.

16. The method of claim 15, wherein the extended portions of the first and second external electrodes extended to the side surfaces of the ceramic body in the width direction are formed to contact the marking layer.
